(19) United States
(12) Patent Application Publication
(10) Pub. No.: US 2026/0323104 A1
(43) Pub. Date: Oct. 15, 2026

(54) CONTENT DELIVERY RATE ADAPTATION INFORMED BY IMPAIRMENTS TOLERANCE PROFILES

(71) Applicant: British Telecommunications Public Limited Company, London Greater London (GB)

(72) Inventors: Brahim ALLAN, London (GB); Michael NILSSON, London (GB)

(21) Appl. No.: 19/476,307

(22) PCT Filed: Mar. 11, 2024
(86) PCT No.: PCT/EP2024/056377

§ 371 Date: Oct. 17, 2025

(30) Foreign Application Priority Data
Apr. 20, 2023 (EP) 23168874.8

(51) Int. Cl. H04N 21/238; H04N 21/24

(52) U.S. Cl. CPC H04N 21/23805; H04N 21/2404

(57) ABSTRACT

A computer implemented method is provided for managing the delivery rate of media content to a client device (200) by a network element (212) over a network, the method comprising the steps of: determining a classification of first media content delivered to and output by the client device (200); determining a tolerance profile to apply at the client device (200) dependent on the classification of the first media content, the tolerance profile being indicative of a media transmission quality acceptable to a user of the client device (200); and delivering the first media content to the client device (200) at a rate dependent on the determined tolerance profile.

### TECHNICAL FIELD

The present invention relates to content delivery for client devices. In particular, the present invention relates to a computer implemented method for managing the delivery rate of media content to a client device by a network element over a network.

### BACKGROUND

TV services today are delivered using various different transmission technologies including broadcast over satellite, cable, terrestrial and IP networks to send the same content to all viewers at the same time; and unicast to deliver an individual stream of content to each viewer over IP networks.

A metric for quantifying the delivery rate of media content is the bit rate-the number of bits that are conveyed or processed per unit of time.

Transmission impairments cause different visual experiences for each transmission technology. Various types of transmission impairments can occur when the bit rate is too low, or is inconsistent over time. Impairments to broadcast services can appear as areas of extreme colour or tearing of the image. Impairments to unicast services can appear as the image freezing or the image quality dropping for a few seconds.

Traditional media content delivery methods discard the user of the client device's perception to transmission impairments to deliver media content.

### SUMMARY OF INVENTION

The invention is defined in the independent claim. Optional features are set out in the dependent claims.

According to first aspect a computer implemented method is provided for managing the delivery rate of media content to a client device by a network element over a network. The method comprises: determining a classification of first media content delivered to and output by the client device; determining a tolerance profile to apply at the client device dependent on the classification of the first media content, the tolerance profile being indicative of a media transmission quality acceptable to a user of the client device; and delivering the first media content to the client device at a rate dependent on the determined tolerance profile.

Such a method of managing delivery rate of media content allows an optimum distribution of transmission resources to a client device when transmission impairments occur. In particular, delivery bit rate for media content is adjusted dependent upon the number or degree of transmission impairments and on the user's tolerance to such impairments. This ensures efficient use of available bit rate/bandwidth between client devices as it can be assigned to different client devices to minimise unacceptable transmission impairments based on individual user preferences.

Optionally the classification of the media content may be provided in metadata received at the client device.

Optionally, the tolerance profile is indicative of one or more thresholds of transmission impairments that can occur during output of the first media content that are acceptable to the user of the client device.

Optionally, the one or more thresholds are determined based on input indicative of the user navigating away from the first media content. Data relating to the user input may be metadata indicative of the client device's engagement with the content and cues such as a command (e.g. a button push or voice command) to change the channel or terminate viewing. This allows for viewing behaviour analysis-the user input can be correlated with the occurrence of a transmission impairment (and related data) to inform the one or more thresholds.

Optionally, the method may further comprise introducing transmission impairments into the first media content. This introduction of transmission impairments is done artificially and may be performed by the network element in the event that no natural transmission impairments have occurred. The introduction of artificial transmission impairments is intended to encourage the user to navigate away from the first media content, allowing one or more thresholds to be determined for the first media content, thus determining a user's individual tolerances to transmission impairments. Artificial introduction of transmission benefits is beneficial because one or more thresholds can be calculated/updated for a viewing session even if no transmission impairments would have occurred based on available system resources.

Optionally, the method may further comprise determining one or more impairment scores indicative of the degree of transmission impairments occurring for the first media content and comparing each impairment score to a respective threshold; wherein delivering the first media content to the client device at a rate dependent on the determined tolerance profile comprises adjusting the first media content delivery rate when at least one of the impairment scores passes their respective threshold.

Adjusting the first media content delivery rate allows the level of transmission impairments to be reduced in multiple ways. For example, the content may be delivered at a more consistent rate, even if that rate has a lower mean that the previous rate. This could, for example, lead to consistent quality at a slightly lower average level but with less stalls, drop-outs and short-lived significant quality drops, giving a lower impairment score for some tolerance profiles. Alternatively, for other tolerance profiles, it may be preferable to increase the mean bit rate to give a lower impairment score.

Optionally, the method may further comprise repeating the steps of determining one or more impairment scores indicative of the degree of transmission impairments occurring for the first media content and comparing the one or more impairment scores to their respective threshold.

Optionally, the impairment score is based on any one or more of: the number of transmission impairments occurring during output of the first media content; the duration of one or more transmission impairments occurring during output of the first media content; or a classification of one or more transmission impairments occurring during output of the first media content.

Optionally, a tolerance profile defines a plurality of thresholds of transmission impairments and individual impairment scores are calculated for each respective threshold. Each impairment score may be determined differently and could be a different combination of any of the number, duration or classification of transmission impairments. For example, an impairment score might solely be based on the number of transmission impairments. Alternatively, an impairment score may be based on the number and duration of impairments occurring for a specific classification of transmission impairment in a given time.

Optionally, a single impairment score is calculated for comparison with a respective threshold, said single impairment score being calculated based on a plurality of other different impairment scores. The plurality of other different impairment scores may be determined by a different combination of any of the number, duration or classification of transmission impairments. The plurality of different impairment scores may be summed up to obtain a single impairment score to compare to the respective threshold.

Transmission impairments occur when the video or audio of the media content stops for a period of time, or when the quality of the video or audio decreases. Optionally, the classification of the transmission impairments includes any one or more of: stalls in which the audio and video pauses for a period of time and resumes playing from the point of pausing; video drops in which the audio and video pauses for a period of time and resumes playing from a point later into the content than the point of pausing; video drops in which the video pauses for a period of time but the audio does not pause, and the video resumes playing from a point later into the content than the point of pausing; or video quality drops in which the video bit rate drops for a period of time.

Optionally, the method may further comprise updating the one or more thresholds based on their respective impairment score reached when the output of the first media content is terminated by user input.

Optionally, a tolerance profile is provided for each classification of media content of a plurality of media content classifications, wherein the method may further comprise creating a global tolerance profile comprising a collection of tolerance profiles for respective classifications of media content associated with a user. The tolerance profile for each classification and the global tolerance profile are both optional features. They are not mutually exclusive-the system could determine a global tolerance profile, or it could determine a tolerance profile for each classification, or the system could determine both.

Optionally, the delivery rate of content to the client device is enforced by a device that connects client devices on a home automation network and controls communications among them. This could be a router.

According to a second aspect there is provided a network element comprising a processor and a memory, the network element being configured to carry out the method of the first aspect, including any one or more of the optional features in combination.

According to a third aspect there is provided a computer program which, when executed on a network element, causes it to carry out the method of the first aspect, including any one or more of the optional features in combination.

### BRIEF DESCRIPTION OF THE DRAWINGS

The disclosure will be further described, by way of example only, with reference to the accompanying drawings, in which:

FIG. 1 is a flowchart illustrating an example method;

FIG. 2 is a flowchart illustrating a further example of the method including updating the client device threshold and tolerance profile;

FIG. 3 is an example setup of the system involved in carrying out the methods described herein; and

FIG. 4 is a flowchart illustrating the method of comparing the impairment score and threshold.

### DETAILED DESCRIPTION OF THE INVENTION

Embodiments and related technology helpful for understanding and implementing the embodiments will now be described with reference to the Figures. The same or similar reference numerals are used to refer to the same or similar components across different Figures.

In general there are several types of video impairments that can occur when transmitting media content via a network such as the internet. Each type of video impairment could affect the user of the client device's desire to continue watching differently. Examples of such video impairments include:
Video stalls: represent rebuffering process, the audio and video pauses for couple of seconds or more.
Video drops with no audio: represent rebuffering process, the audio and video pauses for couple of seconds or more, however unlike the stalls when the content resumes playing, it is not from the point of pausing but a couple of seconds or more later into the content.
Video drops with audio: represent rebuffering process, the video pauses for couple of seconds or more but not the audio, however unlike the stalls when the content video only resumes playing, it is not from the point of pausing but a couple of seconds or more later into the content.
Video quality drop: represent a drop in video bit rate for a couple of seconds or more. The audio plays continuously.

The first three types can occur when the client device runs out of data and has to wait for more. The two “video drop” cases, are possible symptoms of some solutions for reducing end to end latency.

The “quality drop” case could occur when the user's device starts to run low on data and the Adaptive Bit Rate algorithm decides to adapt to a lower quality for a period of time to reduce the amount of data needed to receive, to maintain playing continuity.

Embodiments provide ways for mitigating for the occurrence of these types of video impairments (and any similar types of impairment) whilst taking into account the individual user's tolerance to such impairments when viewing media content.

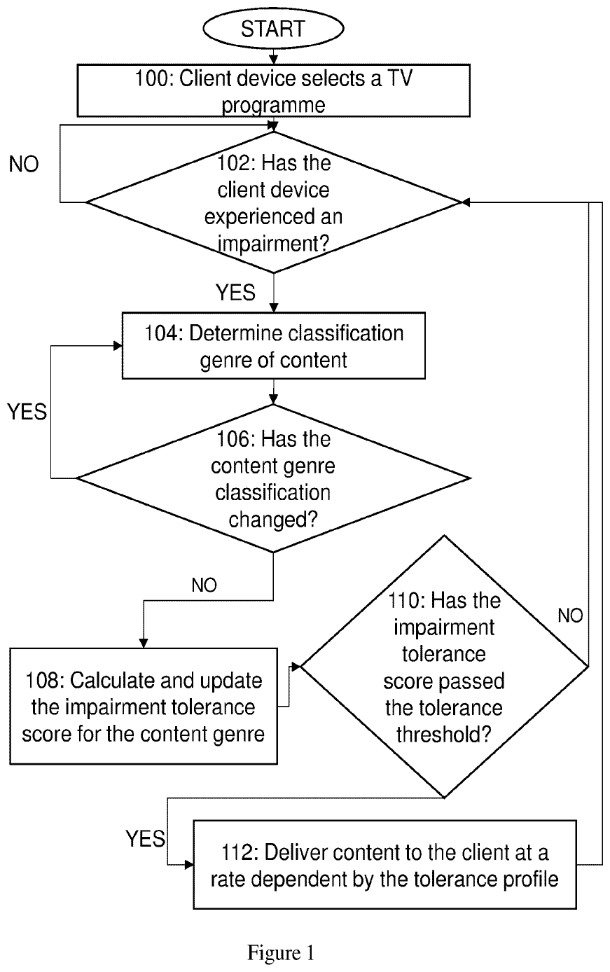

FIG. 1 shows a method of managing the delivery rate of media content to a client device 200(a-d) by a network element 212 over a network 208. The method starts with a user, at step 100, selecting media content, such as a television programme, on their client device 200(a-d).

At step 102 it is determined if a client device 200(a-d) experiences a transmission impairment. This can be determined by monitoring for such impairments and determining their properties (e.g. duration, type etc) in a known manner.

At step 104 a classification of the media content 204 is determined so that the relevant thresholds can be applied. The classification 104 of the media content 204 may be provided in metadata received at the client device 200. The media content 204 may be classified into classes and subclasses. The media content 204 may, for example, be classified into classes for ‘sport’, ‘news’, ‘drama’ or ‘comedy’. Subclasses may be provided for each class. For example, the class ‘sport’ might have the subclasses of ‘football’ and ‘rugby’. The subclasses may be further classified as desired. For example, ‘football’ might be further classified into individual football sports teams.

If the client device 200(a-d) has not terminated the output of the media content and/or has not switched to another media content classification, usage and impairments data about the client device 200 is collected and used to update one or more impairment tolerance scores for the associated media content 108. This process may optionally continue until the client device 200 terminates the viewing session (i.e. the user terminates the media content 204 or switches to another media content classification 106). The data collected includes both input from the user of the client device 200 as well as information relating to any transmission impairments. The data relating to input from the user includes information indicative of the client device's engagement with the content and cues such as commands (e.g. a button push or voice command) to change the channel or terminate viewing. The information relating to the transmission impairments may include information about the number, duration and classification of transmission impairments. The data relating to user input and the data relating to the transmission impairments may be collected repeatedly throughout the viewing session. The data may be collected periodically or continuously as required. As the data is collected throughout the viewing session, the network element 202 does not wait until the end of the selected media content to calculate the impairment tolerance scores.

The impairment scores may be calculated based upon the number or duration of a particular classification of transmission impairment over a given period of time. For example, the number of impairments per hour or the number of minutes of impairments occurring per hour may be used.

At step 110 the impairment tolerance scores for the viewing session are compared to their respective thresholds for the media content classification.

At step 112 the comparison of the one or more impairment tolerance scores with the corresponding thresholds is used to inform the delivery rate of the media content 204.

The delivery rate of the media content can be adjusted based upon one or more of the thresholds being exceeded. Optionally, if a single impairment score passes a respective threshold, the delivery rate of media content can be adjusted accordingly. Alternatively, an adjustment of the bit rate may only be implemented when multiple impairment scores pass their respective thresholds.

If none of the impairment scores pass their respective thresholds, the method iterates or repeats by reverting back to step 102 until at least one score passes its corresponding threshold or until the user terminates engagement of the client device 200 with the media content.

The delivery rate of the media content may be adjusted in any appropriate manner to reduce one or more of the impairment scores. This may involve increasing available resources to the client device such that bit rate increases so as to reduce the occurrence of one or more types of transmission impairments. In some examples the average bit rate over a period time may be increased or decreased as appropriate at the expense of instantaneous bit rate, or bit rate over a shorter period of time, so as to provide a more consistent rate of receipt of media content and thus reduce one or more of the types of transmission impairment.

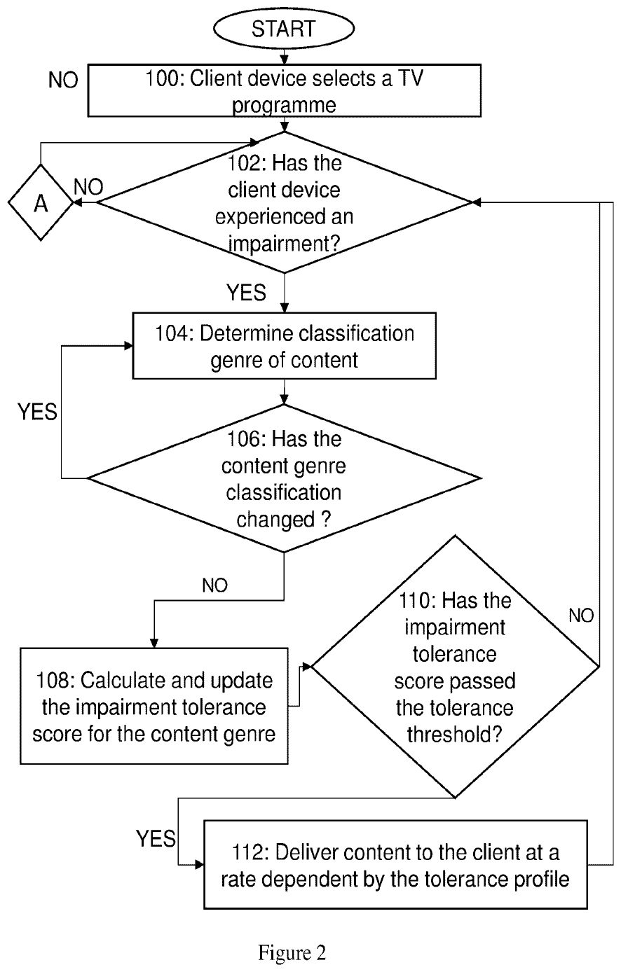

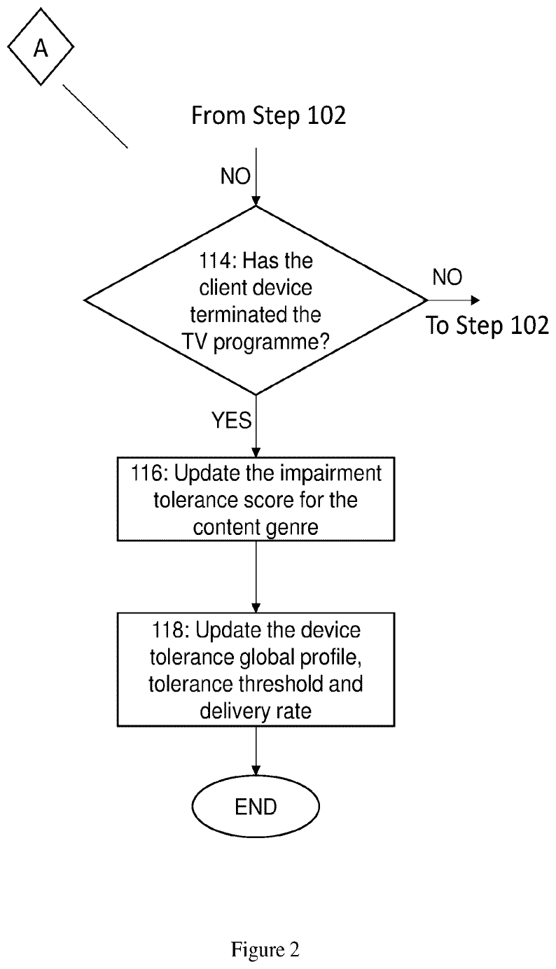

FIG. 2 is a flowchart illustrating the method described in relation to FIG. 1, but including the optional feature of updating a global tolerance profile and the optional feature of updating the one or more thresholds in line with the impairment scores calculated at the end of a viewing session.

The system repeatedly (e.g. periodically) monitors the delivery of media content to detect transmission impairments. If there is a transmission impairment detected at step 102, the method from steps 104, 106, 108, 110 and 112 of FIG. 2 is followed, starting at step 104 (as described above in reference to FIG. 1) to calculate the impairment scores and compare these scores with a respective threshold.

Initial values for each threshold may optionally be set before the method is carried out for the first time. Each threshold may be predetermined based upon user requirements for example.

However, optionally the method may continuously seek to increase the accuracy of the one or more thresholds 220 to conform more closely to a level at which the user of a client device 200 will most likely stop requesting media content 204 due to the occurrence of transmission impairments. Each threshold 220 may therefore optionally be initially determined and/or subsequently adjusted based upon the respective impairment score reached when the output of the first media content is terminated by user input.

In some scenarios, insufficient transmission impairments 206 may have been detected over a specified period of time, such as during a viewing session or a certain proportion of a viewing session, in order to allow a user's tolerances to transmission impairments to be determined. In such cases an optional feature may be implemented in which the network element 202 artificially introduces transmission impairments in order to determine the threshold and update the tolerance profile of the user. The artificial transmission impairments could be introduced in multiple ways. This could include one or more of: introducing transmission impairments of one or more predetermined classifications; introducing a predetermined number of transmission impairments; and/or introducing transmission impairments that occur for a predetermined period of time, either individually or in total.

If, at step 114, the client device 200 is determined to have terminated the media content by navigating away from the media content to other content or turning the content off (e.g. by turning the client device off), the impairment tolerance scores are updated at step 116 for the respective media content classification. Input indicative of the user navigating away from the first media content 204 may be provided via pushing one or more buttons on a remote control device, providing input to the client device via a touch screen or other input device, or via one or more voice commands.

If the client has not terminated the media content, the method may continue until the client eventually terminates the media content. As long as the client device 200 is outputting the media content, usage and impairments metadata information about the client device 200 is collected and used to continuously update the impairment tolerance score.

Since the method described herein is dynamic, with the client device 200 constantly requesting content, the overall effectiveness of the method in delivering content to the client device 200 at a rate dependent on the determined tolerance profile is monitored. To do so, at step 116, the network element 202 calculates and updates the corresponding impairment scores for each content class and subclass for the viewing session. If the impairment scores have changed over the session, an assessment is made as to whether the tolerance profile 226 should be updated.

A tolerance profile 226 is determined for each content class and, optionally, each subclass. A tolerance profile 226 defines at least one threshold, and optionally a plurality of thresholds, of transmission impairment. Where a plurality of thresholds are defined, each threshold is associated with a respective impairment score.

For example, a tolerance profile for a specific user for a specific media content 204 classification could specify one or more of the following example thresholds for transmission impairments:
Stalling: One stall up to 15 s per hour of content is acceptable (i.e. more than one stall up to 15 seconds per hour would breach the threshold).
Stalling: Four stalls with total duration up to 10 s per hour are acceptable (i.e. more than four stalls having a total combined duration of 10 seconds per hour or more would breach the threshold).
Drop-out: None are acceptable.
Quality Drop: One significant drop for up to 30 s per hour is acceptable (i.e. more than one drop exceeding a predetermined quality metric and lasting for up to 30 seconds per hour would breach the threshold).
Quality Drop: Five noticeable drops with total duration up to 120 s per hour are acceptable (i.e. more than five drops exceeding a predetermined quality metric and having a combined duration of 120 second per hour would breach the threshold).
Lower Quality: Continuous consistent good quality standard definition is acceptable.

An adjustment of the bit rate for content delivery could be applied if the impairment score for any of the specified thresholds is breached. Alternatively, a combination of two or more of the thresholds may need to be breached for bit rate to be adjusted.

Alternatively, a single impairment score could be calculated for comparison with a respective threshold, said single impairment score being calculated based on a plurality of other different impairment scores. For example, a tolerance profile may specify a single impairment score, for a specific user for a specific media content classification, which could be calculated by combining a plurality of impairment scores to derive a single score. For example, a single impairment score may be calculated as the sum of the following:
Stalling: Two times number of stalls plus total stall duration (measured in seconds).
Drop-out: Twenty times number of drop-outs plus ten times total drop-out duration.
Quality: Sum over quality levels below good quality standard definition (duration at quality level times non-linear function of quality level).

As well as updating the tolerance threshold, at the end of the viewing session, the global tolerance profile is updated at step 118. The global tolerance profile comprises a plurality of tolerance profiles for different respective media content classes and the corresponding threshold(s)for each media content class. As the delivery rate is dependent on the tolerance profile, the delivery rate may also be updated at step 118 at the end of a viewing session. It is to be noted that the global tolerance profile and the tolerance profile are both optional features—having both is not essential to the method.

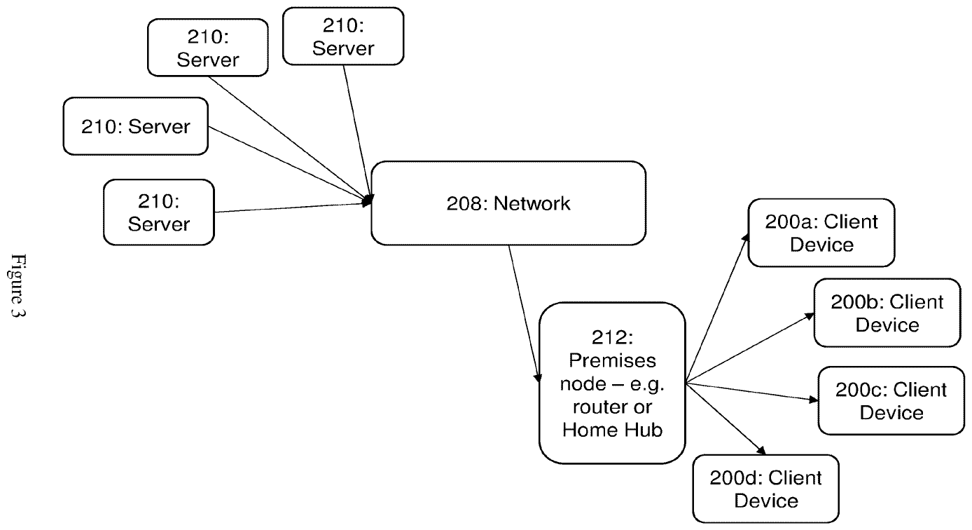

FIG. 3 shows an example setup of the system elements involved in carrying out the method. One or more servers 210, provide media content upon request to the client devices 200(a-d). The servers provide the metadata about the media content being transmitted, including the classification information for each programme. The servers provide the media content and metadata to the network 208 (e.g. the internet) and to network element 212 which manages the delivery rate of media content to the client devices 200(a-d). The device 212 may connect the client devices 200(a-d) to a home network. The device 212 could be for example a router and may have additional functionality such as a BT Home Hub. The client devices 200 connected to the device 212 could include user devices for receiving and consuming media content, for example, mobile phones, televisions, tablets, laptops and other types of computer.

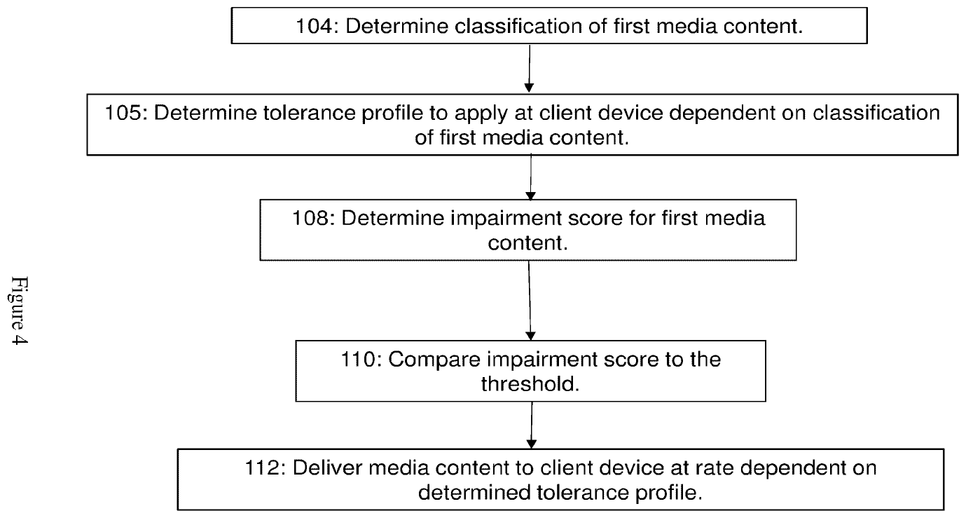

FIG. 4 shows an example method of determining an impairment score and comparing it to a respective threshold. When a client device 200 receives and outputs media content for viewing, the media content is first classified at step 104. This ensures the corresponding tolerance profile is applied to the media content for comparison of the relevant threshold(s) with the impairment score(s) for a given viewing session. The impairment tolerance score(s) may then be determined, at step 108, for the first media content and can be based on any one or more of the number, duration and classification of the transmission impairments as described above. Once an impairment score has been determined, it is compared, at step 110, to the corresponding threshold for the media content classification as defined by the user tolerance profile. This comparison is used to inform the delivery rate of media content to the client device 200 via the network element 212 over the content delivery network at step 112. The delivery rate may be adjusted when the impairment score passes the respective threshold. The adjustment could, for example, include an increase in bit rate or delivering the content at a rate with a lower mean than the previous rate to provides a more consistent rate overall as described above. Other embodiments will be apparent to those skilled in the art from consideration of the specification and practice of the embodiments disclosed herein. It is intended that the specification and examples be considered as exemplary only.

In addition, where this application has listed the steps of a method or procedure in a specific order, it could be possible, or even expedient in certain circumstances, to change the order in which some steps are performed, and it is intended that the particular steps of the method or procedure claims set forth herein not be construed as being order-specific unless such order specificity is expressly stated in the claim. That is, the operations/steps may be performed in any order, unless otherwise specified, and embodiments may include additional or fewer operations/steps than those disclosed herein. It is further contemplated that executing or performing a particular operation/step before, contemporaneously with, or after another operation is in accordance with the described embodiments.

The methods described herein may be encoded as executable instructions embodied in a computer readable medium, including, without limitation, non-transitory computer-readable storage, a storage device, and/or a memory device. Such instructions, when executed by a processor (or one or more computers, processors, and/or other devices) cause the processor (the one or more computers, processors, and/or other devices) to perform at least a portion of the methods described herein. A non-transitory computer-readable storage medium includes, but is not limited to, volatile memory, non-volatile memory, magnetic and optical storage devices such as disk drives, magnetic tape, compact discs (CDs), digital versatile discs (DVDs), or other media that are capable of storing code and/or data.

Where a processor is referred to herein, this is to be understood to refer to a single processor or multiple processors operably connected to one another. Similarly, where a memory is referred to herein, this is to be understood to refer to a single memory or multiple memories operably connected to one another.

The methods and processes can also be partially or fully embodied in hardware modules or apparatuses or firmware, so that when the hardware modules or apparatuses are activated, they perform the associated methods and processes. The methods and processes can be embodied using a combination of code, data, and hardware modules or apparatuses.

Examples of processing systems, environments, and/or configurations that may be suitable for use with the embodiments described herein include, but are not limited to, embedded computer devices, personal computers, server computers (specific or cloud (virtual) servers), hand-held or laptop devices, multiprocessor systems, microprocessor-based systems, set top boxes, programmable consumer electronics, mobile telephones, network personal computers (PCs), minicomputers, mainframe computers, distributed computing environments that include any of the above systems or devices, and the like. Hardware modules or apparatuses described in this disclosure include, but are not limited to, application-specific integrated circuits (ASICs), field-programmable gate arrays (FPGAs), dedicated or shared processors, and/or other hardware modules or apparatuses.

Client devices can include, without limitation, static user devices such as PCs and mobile user devices such as smartphones, tablets, laptops and smartwatches.

User input devices can include, without limitation, microphones, buttons, keypads, touchscreens, touchpads, trackballs, joysticks and mice.

1. A computer implemented method of managing the delivery rate of media content to a client device by a network element over a network, the method comprising:
determining a classification of first media content delivered to and output by the client device;
determining a tolerance profile to apply at the client device dependent on the classification of the first media content, the tolerance profile being indicative of a media transmission quality acceptable to a user of the client device; and
delivering the first media content to the client device at a rate dependent on the determined tolerance profile.

2. The method of claim 1 in which the tolerance profile is indicative of one or more thresholds of transmission impairments that can occur during output of the first media content that are acceptable to the user of the client device.

3. The method of claim 2, wherein the one or more thresholds are determined based on input indicative of the user navigating away from the first media content.

4. The method of claim 3, further comprising introducing transmission impairments into the first media content.

5. The method of claim 2 further comprising:
determining one or more impairment scores indicative of the degree of transmission impairments occurring for the first media content; and
comparing each impairment score to their respective threshold;
wherein delivering the first media content to the client device at a rate dependent on the determined tolerance profile comprises adjusting the first media content delivery rate when at least one of the impairment scores passes its respective threshold.

6. The method of claim 5 further comprising repeating the steps of determining one or more impairment scores indicative of the degree of transmission impairments occurring for the first media content and comparing the one or more impairment scores to their respective threshold.

7. The method of claim 5 wherein the impairment score is based on any one or more of:
the number of transmission impairments occurring during output of the first media content;
the duration of one or more transmission impairments occurring during output of the first media content; or
a classification of one or more transmission impairments occurring during output of the first media content.

8. The method of claim 7 wherein:
a tolerance profile defines a plurality of thresholds of transmission impairments, each threshold of the tolerance profile being associated with a respective impairment score.

9. The method of claim 7 wherein the classification of the transmission impairments includes any one or more of:
stalls in which the audio and video pauses for a period of time and resumes playing from the point of pausing;
video drops in which the audio and video pauses for a period of time and resumes playing from a point later into the content than the point of pausing;
video drops in which the video pauses for a period of time but the audio does not pause, and the video resumes playing from a point later into the content than the point of pausing; or
video quality drops in which the video bit rate drops for a period of time.

10. The method of claim 2 further comprising updating the one or more thresholds based on their respective impairment score reached when the output of the first media content is terminated by user input.

11. The method of claim 1 in which a tolerance profile is provided for each classification of media content of a plurality of media content classifications.

12. The method of claim 11 further comprising creating a global tolerance profile comprising a collection of tolerance profiles for respective classifications of media content associated with a user.

13. The method of claim 1 in which the delivery rate of content to the client device is enforced by a device that connects client devices on a home automation network and controls communications among them.

14. A network element comprising a processor and a memory, the network element being configured to carry out the method of claim 1.

15. A computer program which, when executed on a network element, causes it to carry out the method of claim 1.
